(19) United States
(12) Patent Application Publication
(10) Pub. No.: US 2004/0259069 A1
(43) Pub. Date: Dec. 23, 2004

(54) Educational, system, method, media and business methods

(76) Inventor: Andrew J. Malinow, New York, NY (US)

Correspondence Address: David Aker, 23 Southern Road, Hartsdale, NY, 10530, US

(21) Appl. No.: 10/873,044

(22) Filed: Jun. 21, 2004

Related U.S. Application Data
(60) Provisional application No. 60/480,444, filed on Jun. 21, 2003.

(51) Int. Cl. G09B 5/00; G09B 25/00

(52) U.S. Cl. 434/365; 434/307 R

(57) ABSTRACT

A system, method (and an article containing computer code for implementing the method) for instruction, wherein the system includes a display having a plurality of display portions, each portion being for representing a different mental representation of a problem; and a flexible control for determining what representations are and are not revealed at a given time, so as to allow for customized lessons and reduction in visual overload. An architecture that supports varied content is provided. The content may comprise a series of frames linked to one another by the architecture. The representations may comprise a verbal statement of a problem; an animation of the problem; a procedure for solving the problem; and a graph of the problem. Business methods for utilization of the invention.

This application claims priority under 35 U.S.C. §119(e) from provisional application Ser. No. 60/480,444, filed on Jun. 21, 2003, which is incorporated herein in its entirety.

### BACKGROUND OF THE INVENTION

1. Field of the Invention

The present invention relates to educational software. More particularly, it relates to educational software for teaching sophisticated concepts at a variety of different levels of understanding, and in particular to educational software wherein several different representations of a problem are represented.

2. Prior Art

There have been a variety of ways proposed to present difficult concepts to students. Mental model reasoning, or “mechanistic thinking” as it is often referred to in the literature, has its origins in research regarding reasoning about complex physical systems (Gentner and Stevens, 1983). Many theorists have discussed mental models (de Kleer, J., & Brown, J. S., 1981; Johnson-Laird, P. 1983).

3. Other Approaches

A mental model was derived from Black's FIPM cognitive architecture (Black, 1993). Black maintains that a complete understanding of a particular problem requires that the person understand that the knowledge state can be represented in several ways. These representations are unique in their expression, but equivalent in their meaning. The different representations according to this model are: a propositional network that represents the declarative knowledge of a given domain; a visual representation that stores information on a pixel coordinate system (Kosslyn, 1980) and which affords the ability to “zoom in and out” on the image depending on the required specificity according to the demands of the task; a procedural representation that shows under what conditions a certain action can occur and which is necessary to solve the problem; and a mental model representation that shows how all of the components work together within the context of the “imaginary world” that is described in the text. A complete mental model requires the student to be aware of the connections between equivalent representations, to be cognizant of how and why the knowledge is equivalent, as well as to recognize their unique properties. Mechanistic thinking allows the student to predict how changes in one part of the problem affects the whole; to reason qualitatively about how and why this change affects the whole in the way that it does and to recognize problems that have the same deep structure (transfer).

All of these approaches are generally theoretical in nature. None of these approaches provides a comprehensive method and apparatus for presenting multiple representation of a problem in a manner which best facilitates learning by a student.

### SUMMARY OF THE INVENTION

It is an object of the invention to provide a method and an apparatus for presenting several different representations of a problem in one unified interface, wherein each representation addresses different components of mental model.

It is a further object of the invention to provide such a method and apparatus that may be used to teach sophisticated subject matter to students at different levels of understanding.

It is a further object of the invention to provide a method and apparatus for teaching mathematical concepts.

It is yet another object of the invention to provide methods of instruction which effectively and efficiently utilize such apparatus.

These objects and others are achieved in accordance with the invention by the simultaneous presentation of procedural as well as more conceptual representations to illustrate the connections between the representations and to facilitate a more complete mental model. The program supports all four of the aforementioned representations. The degree of improvement in these knowledge structures will vary from student to student. The program is flexible enough to work in a number of contexts: the underlying architecture can accommodate virtually any content. For example in one embodiment, probability problems could be solved by linking an animation depicting a die being rolled, or marbles being pulled from a bag, or to a tree diagram that grows dynamically as the die-rolling or marble choosing occurs. The student can then manipulate the animation (by fast-forwarding or rewinding) to see how the tree expands or contracts over time. These are all graphical representation of the problem. In the graphical quadrant, while the specific image that is used is dictated by the particular content area that it represents, the image can be analyzed at different degrees of detail depending on the nature of the task. For example, when the system is used to teach proportions, if the student is asked to label the axes, it is not necessary to reveal the quadrants that add the appropriate scale to the graph or plot the data points because the question posed to the student does not require this level of analysis. This structure defines the graphical quadrant of the system in all instances and is content independent.

The architecture is not restricted to math. Subsequently the program can adapt any state testing material, such as state proficiency exams, into the 4-quadrant interface. Because any domain of knowledge can be represented, the task simply becomes finding the best representations to depict the different components of the domain.

The tool can be used in a number of contexts. In one embodiment it can be used in a classroom setting, including inclusion classrooms, as an interactive blackboard. In this capacity the teacher can project the program onto a screen or whiteboard by connecting a computer to an LCD projector, and then deliver an interactive lesson, in which he/she manipulates the interface in various ways to serve his/her educational goals.

In another embodiment the program can be used in a computer lab. The teacher can work from a main console, while students follow along on their own computers. After modeling a problem or two, the teacher can then leave the students to explore the program on their own. The students' interactions with the program can be tracked, recorded and stored in a database, which in turn can provide teachers with a diagnostic tool to examine which representations the students had been working on, and which they were avoiding. For example, a student may consistently go straight to the procedural quadrant without looking at the animation or graph. The teacher can assess if this pattern of behavior affects the student's thinking in a detrimental way, for example, by examining performance on a quiz that includes graphing. If indeed the student did poorly on the graphing section of the quiz, the teacher could instruct the student to spend more time examining the graph, the animation and the relationship between them, and be able to track whether or not the student complied. In this capacity the program can be used to model the student's thinking and record it so it can be examined at a later date. This function is useful for teachers who want to use the results to provide parents with incite into their child's learning processes, as well as to gather information about the student for their own teaching purposes.

In yet another embodiment the program can be connected to a SMART Board™ display, supplied by SMART Technologies, Inc. of Calgary, Alberta, Canada allowing teachers to record their own interactions with the program as well as their accompanying lecture, as they are giving it. The integrated file (.mpeg or .avi) that the SMART Board display creates instantaneously, can than be uploaded and viewed at any time, using any web-browser. A student who has missed class can then look at the file and get the exact lesson that the teacher had given, including every button clicked and screen presented, as well as the questions that the teacher asked and any explanations the teacher may have given to the class. In this manner, the student at home is not only able to access the program, but is also able to benefit from the teacher's lesson.

Lessons can be archived in an electronic library, so that students and teachers have access to all lessons, including lessons from previous years as well as from different classes. Having an electronic archive allows tutors, resource/special education and regular classroom teachers, as well as students, to have access to a wide range of different lessons and perspectives in a number of different content areas. The movies that are generated can be used for teacher training on best-practices or in service training for new teachers. The lesson files can also be used to demonstrate the SMART board and this particular function to schools that were interested in acquiring a SMART board.

The database of lessons is preferably searchable by a number of fields so that any of the aforementioned entities could cross-reference different schools in a consortium to gather all lessons on a subject, thus gaining exposure to different styles and multiple perspectives.

In still another embodiment the students can also use the program on the SMART Board display. Students can take turns working on problems in front of the class. By doing so, the teacher can examine how the student approaches the problem and students can learn from each other as the student's interaction with the program on the board can be used to facilitate an active discussion on the material that is being presented. Once again, the students' use of the program on the SMART Board display can be recorded, saved, and used for later assessment purposes (i.e. as part of an electronic portfolio).

While the tool is web-based allowing for cross-platform use, in one embodiment it can also be run over a LAN network, so only the school that has a license can use it. Because the program can be used with different grades and subjects without changing the architecture, a LAN network allows different teachers to use the program simultaneously. In addition, teachers may want to use the program simultaneously in several different settings using the same content. For example, a resource room teacher might need to access the program, while another teacher is using it in a regular classroom. Because the degree of difficulty of the material can be controlled by the teachers' pedagogical approach depending upon with whom they are using the program (for example, students who are just beginning to learn the material, or are below grade level might need more exposure to the animation while students in later grades might have a lesson that utilizes the graphical representation more) a LAN connection affords the school the ability to run the program in several classes simultaneously.

In a further embodiment of the invention, the program can be burned onto a CD and bundled with textbooks, to be used to provide homework assignment problems or end of chapter review. Textbook publishers can provide the content. The program can then provide a multi-media presentation of the material. The teacher can assign homework that is aligned with the way the problems are presented in the program.

In yet another embodiment, the program can be embedded in educational games. The game can provide the content and context for each problem, while the interface provides an interactive component that the student can use once the game had provided the specific problems. For example, many games use a linear structure that moves the user from problem to problem within a game environment that presents a cover story for the problems. When the students have to answer the problem, they are often just provided with a prompt to enter their answer. By using the architecture of the invention, the problem can be formatted into the four quadrants, allowing more sophisticated questions to be asked of the students.

Thus, the invention is directed to a system for providing instruction to one or more students, a method for providing instruction using the system, a method for operating a computer system to provide such instruction, and a computer readable medium (such as a computer disc or CD) having thereon computer readable code for causing the computer to perform the method for providing instruction. It is also directed to a business method for distributing and such media, and for pooling resources of those to whom the media have been distributed. Further details of the invention are set forth in the description below and in the appended claims.

### BRIEF DESCRIPTION OF THE DRAWINGS

The foregoing aspects and other features of the present invention are explained in the following description, taken in connection with the accompanying drawings, wherein:

FIG. 1 is a screen shot of the opening screen in version 1, where all 4 quadrants are presented at once.

FIG. 2 is a screen shot of the opening screen in version 2, where only the text quadrant is presented.

FIG. 3 is a screen shot of the presentation of the text with the procedural quadrant in version 2.

FIG. 4 is a screen shot of the presentation of text with animation quadrant in version 2.

FIG. 5 is a screen shot of the presentation of text with graph in version 2.

FIG. 6 is a screen shot that shows all four sections hidden in version 2.

FIG. 7 is a screen shot that show the connection between the animation and the graph.

FIG. 8 is a screen shot that shows the presentation of the cross-multiplication solution in the procedure quadrant in version 1.

FIGS. 9a to 9d are screen shots that show the presentation of the cross-multiplication solution steps in the procedure quadrant in version 2.

FIG. 10 is a screen shot that shows the connection between the procedural, text and animation quadrants during the “Set up a proportion function” in version 2.

FIG. 11 illustrates the over all program structure of the graph, procedures, text and animation quadrants.

FIG. 12 illustrates the overall program structure of the summarize quadrant that replaces the procedure quadrant in FIG. 10.

FIG. 13 illustrates the functional interaction between the text quadrant and procedure quadrant.

FIG. 14a is a structural diagram of the interaction between the animation and graph quadrants.

FIG. 14b is a functional diagram of the interaction between the animation and graph quadrants.

FIG. 15 is a functional diagram of the interaction between the procedure, text and animation quadrants during the “set up a proportion” function.

FIG. 16a is an overall functional description of the user's experience with the procedural, text, animation and graph quadrants.

FIG. 16b is an overall functional description of the user's experience with the summarize quadrant.

FIG. 17 is a combination flow chart and block diagram showing the manner in which the present invention may interact with a web based teaching tool.

### DETAILED DESCRIPTION OF THE PREFERRED EMBODIMENTS

While different computer systems and platforms can be used, the present invention, by way of illustration and not by way of limitation, may be implemented for use in a web browser environment. The web browser may operate on an IBM or PC compatible computer running a Windows® operating system. Again, only by way of example, the program may be implemented by using Macromedia Flash MX. Flash MX was chosen for its cross-platform capability and seamless integration with the world wide web. In addition, the structure of Flash MX is conducive to making structural changes to the program relatively quickly. Because Flash MX works by generating a number of movie files that are loaded into different targets on the screen, it is easy to swap different movies in and out of the interface. Further, by way of example, the invention is illustrated herein with reference to the teaching of mathematical concepts relating to proportions. However, the method and system may be used to teach many different concepts and subjects.

Two versions of the invention were developed. Version 1 is described to provide a context for the revisions that are represented in version 2. Version 2 is the most preferred embodiment.

A goal for version 2 is to make the system more flexible so that the teacher or student can control what representation or combination of representations they would like to view. Making the system more flexible also allows the teacher to customize use of the tool. By rearranging and presenting representations in combinations that the teacher thinks fit, the teacher can adapt the system to his or her own personal specifications and align it with his or her own pedagogical approach. This allows the teacher to adjust the tool to a particular grade level. For example, a teacher who is first introducing proportions to the students can structure their lesson so that the students have very little exposure to the graph or procedure quadrants. Conversely, more advanced students could receive an introductory lesson on graphing and functions, by focusing on the graph quadrant. Allowing the teacher to control what is and is not shown makes the tool flexible enough to serve a number of different grades and populations of students.

In addition to the flexibility that was built into the system, some structure was added to the flow of the program to provide the teacher with a built in review component that should be followed in order to proceed to the next problem. In addition to providing an important recapitulation of all of the steps that the students had just taken, structuring the program in this manner made it easier to navigate to the next problem.

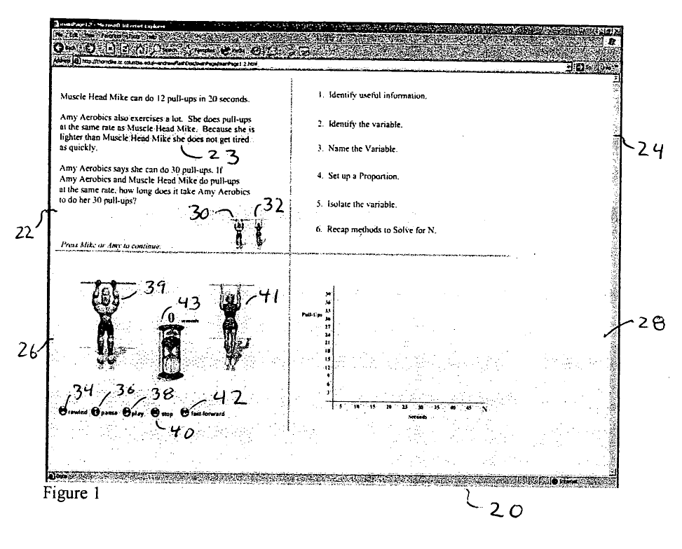

Referring to FIG. 1, in a screen presentation 20 in accordance with the invention, there are four quadrants. These include a text quadrant 22 with text 23, a procedural quadrant 24, an animation quadrant 26 and a graph quadrant 28. Clicking on either of the representations 30 or 32 of the fictional persons described in the text 23 of the text quadrant 22, causes the program to continue. Animation quadrant 26 includes a rewind button 34, a pause button 36, a play button 38 a stop button 40 and a fast-forward button 42. The animation includes a first FIG. 39 doing pull ups, a second FIG. 41 doing pull-ups, and a representation of a timing device 43.

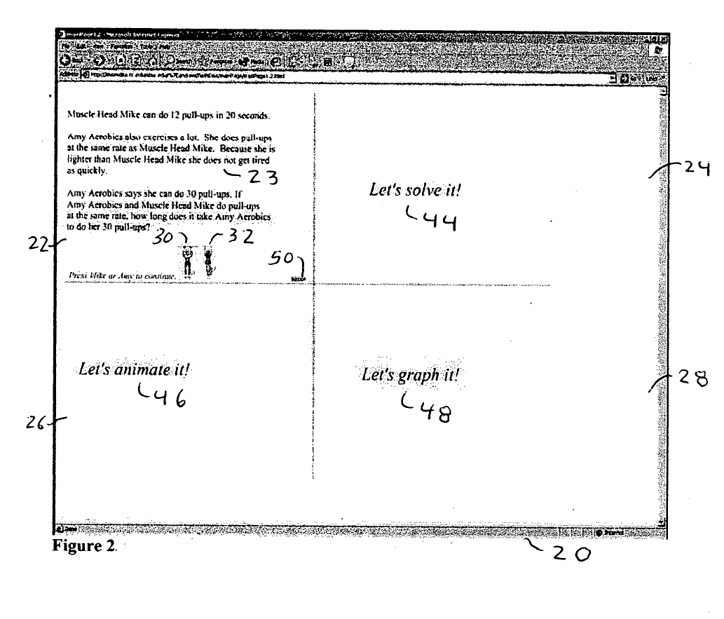

Referring to FIG. 2, while version 2 retains the same four quadrant layout as version 1 (FIG. 1), when the user is prompted on the first screen to click on a continue button (representations 30 or 32) in version 2, instead of being presented with all four screens at once as in version 1 (FIG. 1), a user is presented with a description of a use 44, 46, 48 for each quadrant, each of these items 44, 46 and 48 being generated by an intermediate movie.

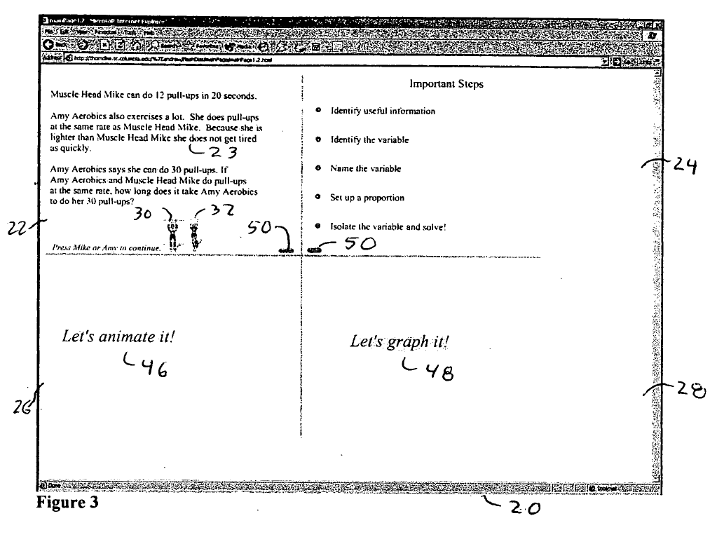

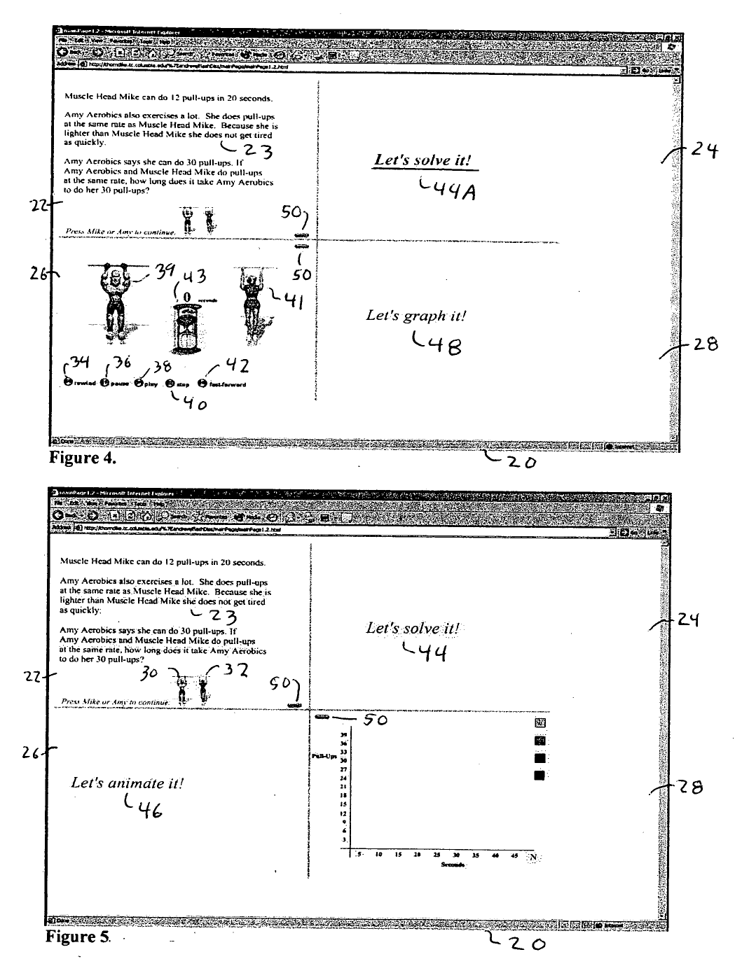

In FIG. 2, instead of loading the procedure, animation and graph quadrants immediately, the depicted intermediate movies are loaded. Each description 44, 46, 48 of the quadrant on the intermediate movies is turned into a button, so that when clicked, it causes the appropriate movie to be loaded into the appropriate target. For example when “Let's solve it!” button 44 of FIG. 2 is clicked, the procedure movie is loaded, in place of the intermediate movie, in the upper right quadrant, as shown in FIG. 3. The user would know that the text was an active button because upon rolling over the text in each quadrant with the cursor, the text would change (for example, turn red, become bold, change size, change style or characteristics, change the nature of the cursor, etc.) as represented by the underlined text 44A in the upper right hand quadrant 24 of FIG. 4. In addition, when displayed, each movie may have a hide region 50 that becomes a hide button, when a cursor is placed over it, as more fully described below.

In order to hide the procedure quadrant 24 (or the text quadrant 22, animation quadrant 26 and graph quadrant 28), a hide button is clicked which re-loads the intermediate movie. The hide button may be designed so that on a rollover of a hide region 50 associated with each quadrant, a description of its function pops up. For example if the user moused over (moved the cursor over) the gray hide region 50, the text “hide procedure” (not shown) appears. The hide region 50 may be located in different places on each movie. This may depend on where the movie is on the screen. For example, for the text quadrant 22 this may be in the lower right, while for the procedure quadrant 24 the hide region 50 may be in the lower left. The hide region for the animation quadrant 26 is preferably at the upper right as shown in FIG. 4. The hide region 50 for the graph quadrant 28 (lower right hand quadrant) is at the upper left of the, as shown in FIG. 5. Thus, all of the hide regions 50 (and their corresponding buttons which appear on a mouse over) may be clustered at positions that are opposites of those of their respective quadrants on the display.

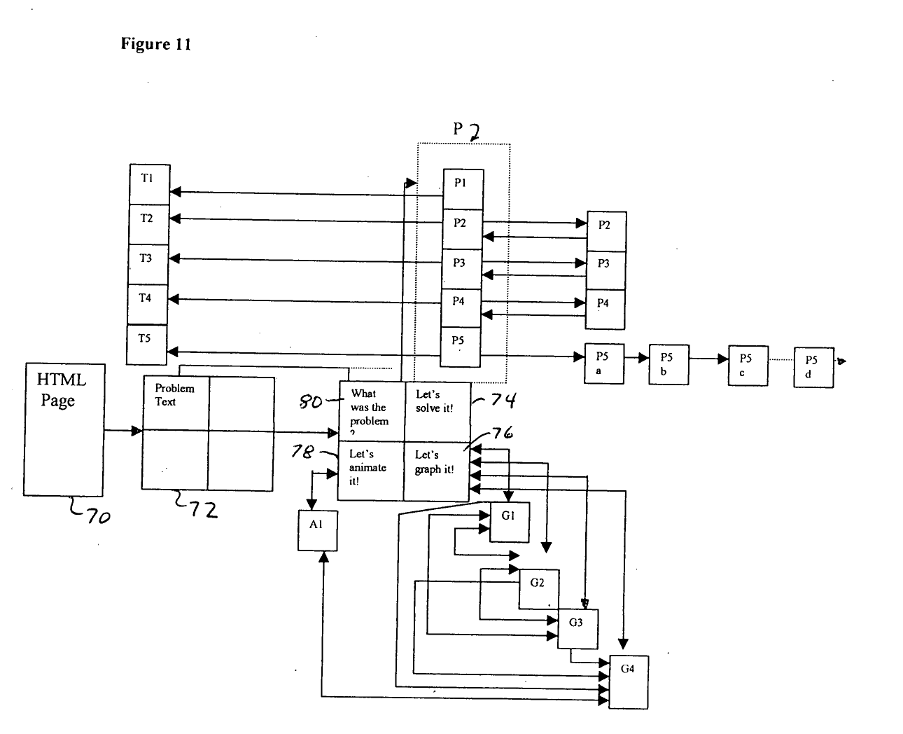

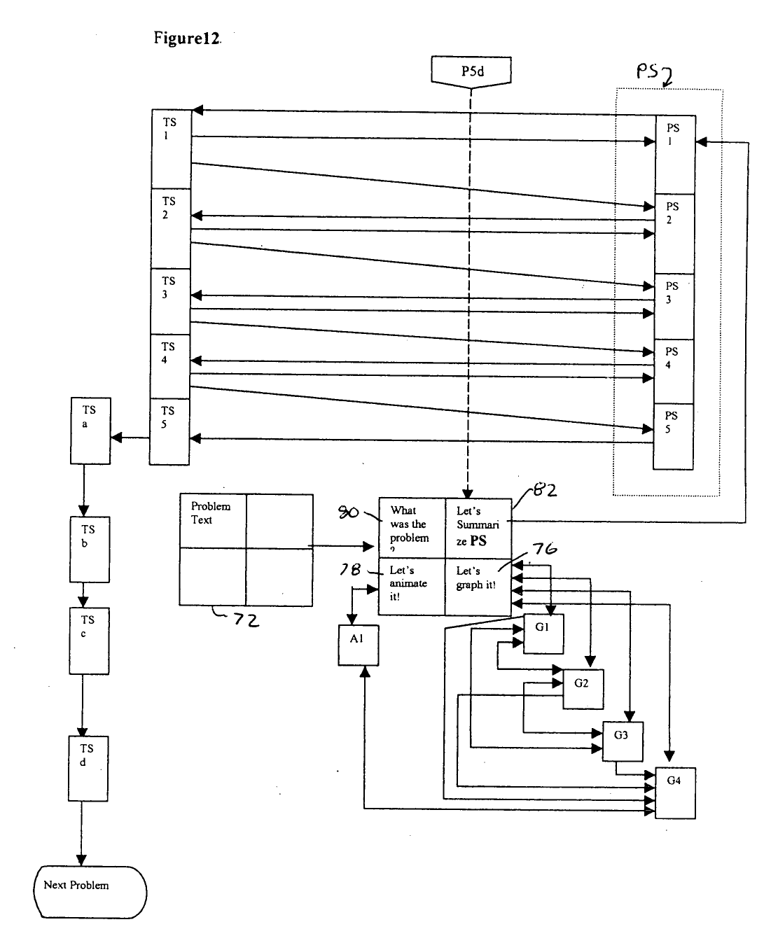

The operation of the text quadrant 22 is an exception because the teacher or student needs a place to start. The program is launched by clicking on an introductory HTML page (FIG. 11) that describes the program and how to use it. A button on this introductory page, when clicked, loads the problem text movie as well as the three intermediate movies, previously described, into their respective targets. If the teacher or student decides to hide the problem text, they can use a button that functions in the same manner as the hide button in the other quadrants. The only difference is that the text quadrant automatically loads in an open state, while the other three quadrants load only after the user decides to load them. Subsequently the user is given the opportunity to toggle between the different screens.

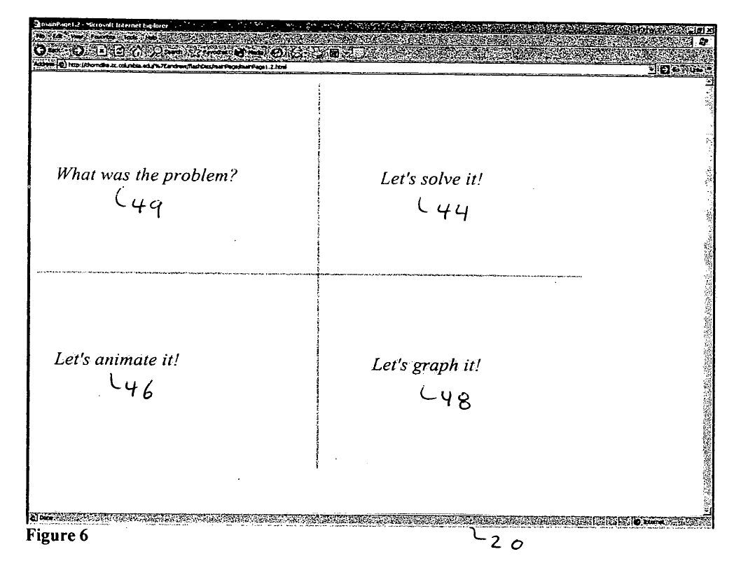

FIG. 6 shows the screen after all of the quadrants have been concealed. The text 49 displayed in the text quadrant is “What was the problem?” Therefore version 2 allows for the teacher to select and combine different quadrants, depending on the pedagogical goals. The teacher can open up one quadrant at a time or several. It is also still possible to open all four, as in version 1.

As in version 1, the representations are linked to each other. However, because different quadrants can be revealed or concealed at the teacher's discretion, there are significantly more ways to illustrate the relationships between the representations. For example if the teacher was presenting an introductory lesson on proportions, and did not yet want the students to think about how to solve the problem, only to understand what it meant that two entities were in proportion, the teacher could just reveal the text and animation. The animation could then be run to illustrate the concept of constant rate. The animation retains all of the functionality as in version 1 and can be paused at any time; the fast-forward button 42 and rewind button 34 can be used to advance and rewind the “play-head” of the animation and the stop button 40 resets the animation completely. As in version 1, the animation is linked to the graph of the graph quadrant 28, so while the animation plays, the relevant points are plotted in the graph quadrant 28. By concealing the graph, the teacher can use the animation to talk about the concept of constant rate in a more concrete way that may be more appropriate for younger or older learning-disabled students, without the distraction of the graph (FIG. 4).

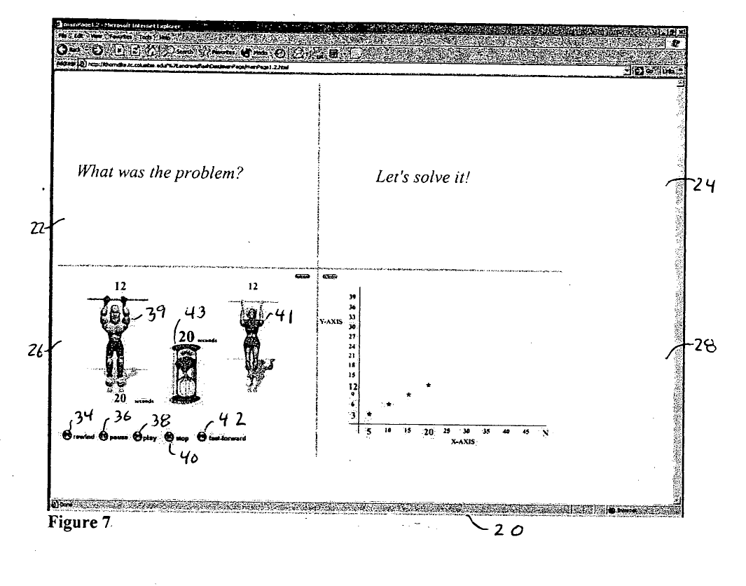

The lesson can become considerably more challenging by simply revealing the graph quadrant 28 and running the animation that would then provide the teacher with the opportunity to engage the students in a more sophisticated discussion of functions and graphs (FIG. 7). By exposing only these two quadrants, full attention can be paid to the graph and the relationship that it shares with the animation. Students are able to explore this relationship without having potentially distracting information from the text and procedure quadrants present on the screen. Once again the choices that the teacher has regarding what information the student is presented with, affords the teacher the ability to tailor the program to meet a variety of educational needs and goals. Version 1 presented three methods for solving the problem. Two of the methods may be deemed to be arcane and not of practical use. However, it is possible that students should still be made aware of the fact that there are several ways to solve a proportion problem. In addition, each method may be presented in its entirety in one movie. However, when several solution steps are placed on one movie file, the screen generally becomes too cluttered. Version 2 addresses this problem by simply stating in the fist step of the procedures: “There are three ways to solve a proportion problem: First we can use the multiplicative inverse; second we can use equivalent ratios; finally we can cross-multiply. For now we are going to focus on cross-multiplying”.

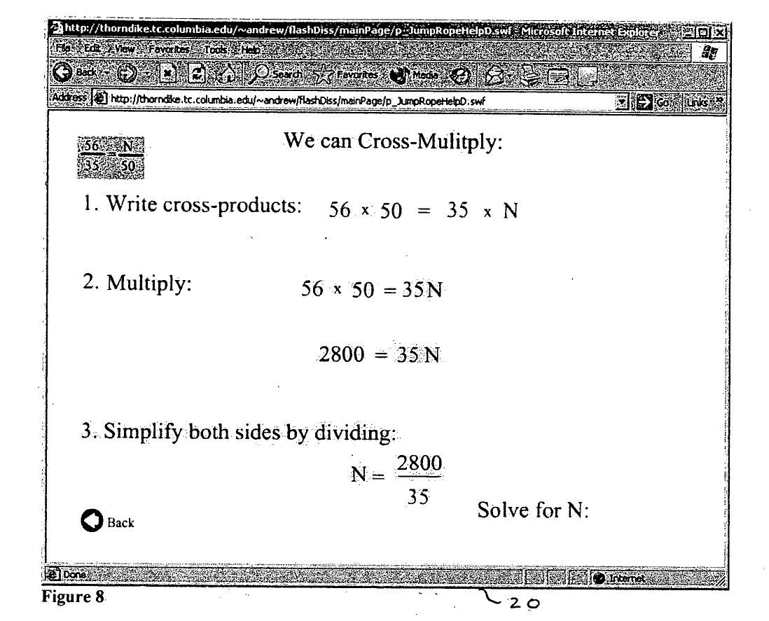

FIG. 8 serves as an example of how too much information may be presented on the screen for the “Isolate the Variable” function in the first version of the program. Subsequently the second version breaks down the content of this function into four separate movie files, rather than one.

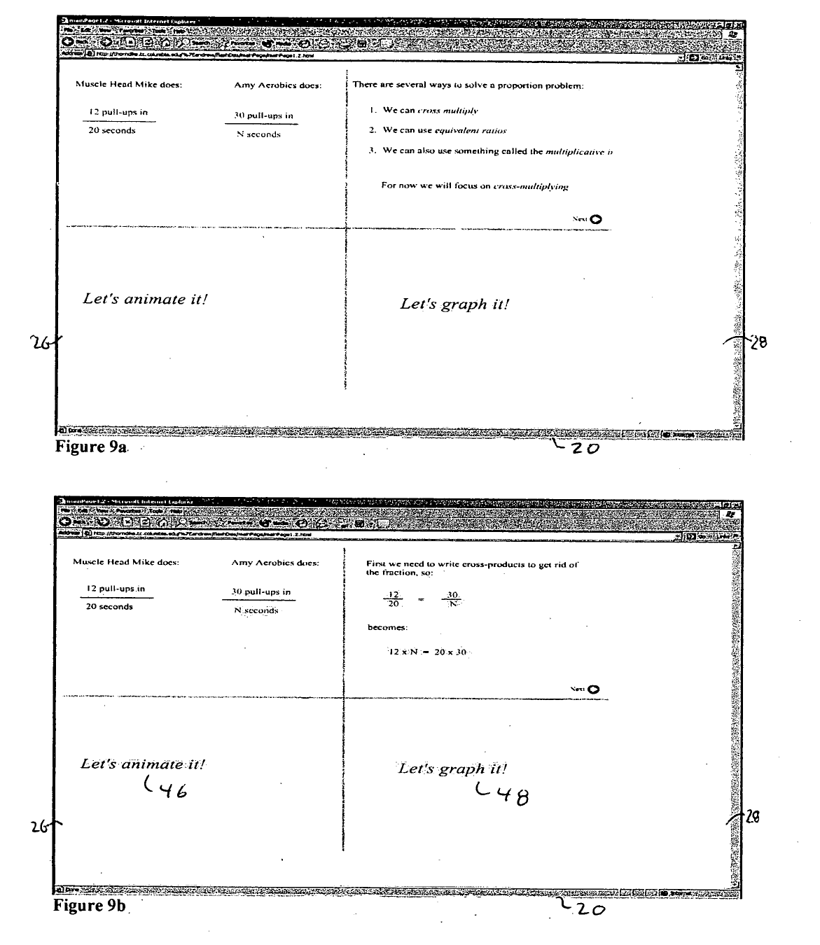

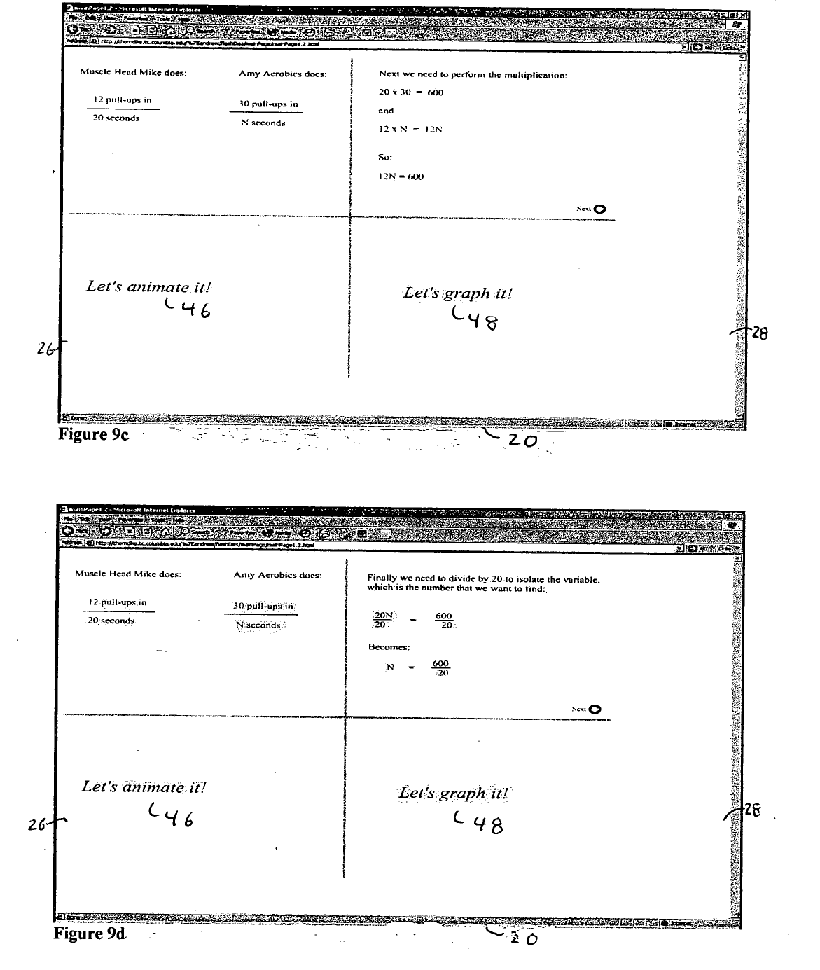

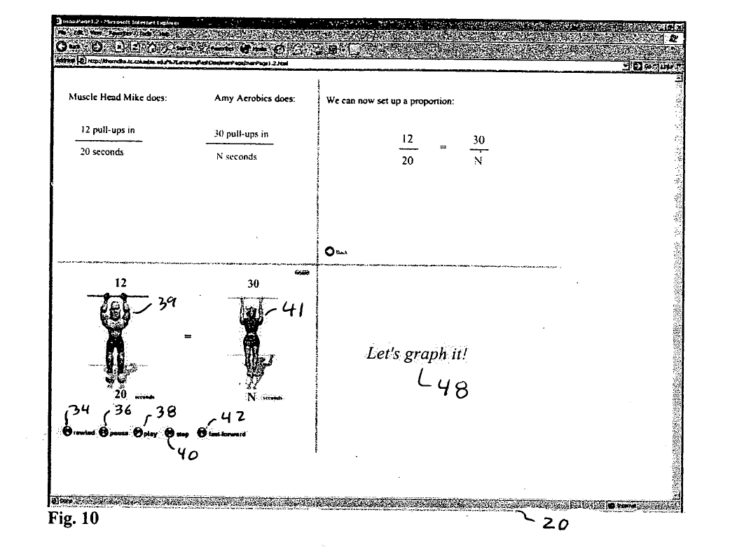

Referring to FIGS. 9a to 9d, version 2 presents the steps required to solve the problem, one step at a time, with each step presented in its own movie file, and it is the teacher (or student) who decides when to move to the next step. When used in a classroom setting, having the teacher control when the next step is revealed, allows the teacher to obtain feedback from the class and to ascertain who may or may not understand the step that is being taken. The teacher is also free to open the other screens while the problem is being solved. For example, FIG. 10 shows how the “Set up a proportion” button in the procedure section is also connected to the animation as well as the text (as also described in FIG. 17).

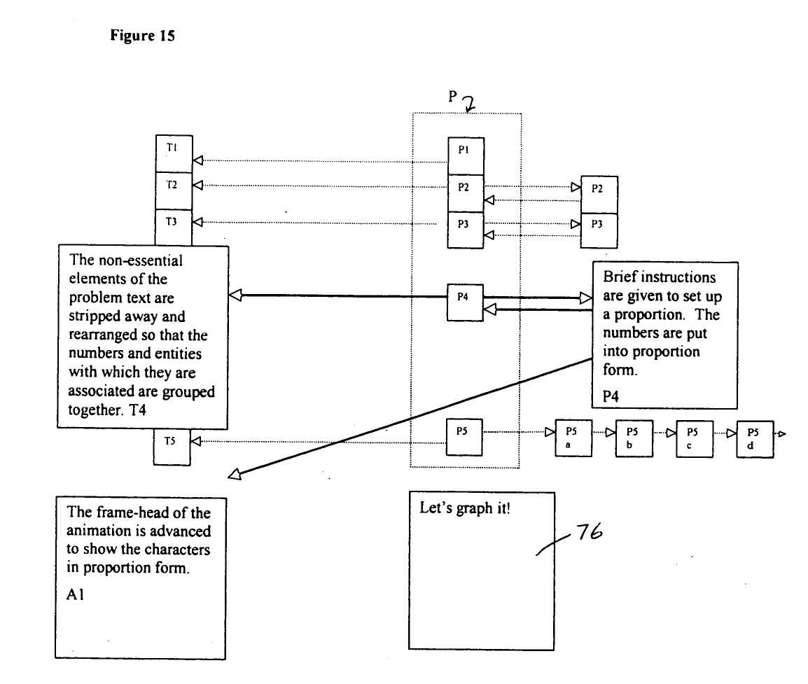

FIG. 11 provides an overall schematic of the program's structure. As described above, the program is introduced with an HTML page 70, leading to, for example, the display of FIG. 2, as represented by 72. In FIG. 11, each variable name represents a movie file that can be called. Arrows indicate buttons on movie files that are able to call other movies and load them to the apprpriate target. For example in FIG. 11, clicking on the “Let's solve it!” button 74 would load movie P into the procedure quadrant. Movie P contains five buttons which load movies P1-P5 respectively. When the button that triggers P2 is clicked, the movie file called P2 is loaded into the procedure quadrant and the movie file called P is unloaded. At the same time, the movie file called T2 is loaded into the text quadrant. There is a button on the P2 file, which, when clicked, will re-load the P movie file. The procedure quadrant controls both the movies that are loaded into the text quadrant as well as those that are loaded into the procedure quadrant. In the case of “Set up a proportion” (P4), the button also controls the animation (FIG. 15). There are similar appropriate arrangments in terms of what movies may be called with respect to the “Let's graph it” button 76, the “Let's annimate it” button 78 and the “What was the problem” button 80.

FIG. 12 provides an overall schematic of how the “summarize” quadrant functions. This part of the program is much more structured than the procedure quadrant 24 and takes the place of the procedeure quadrant on the screen. The summarize quadrant is a movie file that is loaded when the user has completed the last step in the “isolate the variable” movie (P5d of FIG. 11). P5d contains a button 82 that loads the summarize movie into the procedure quadrant 24. The user cannot proceed backwards into the procedure quadrant once the summarize movie has been loaded. However the user can still click on the “What was the problem?” button 80 for text quadrant 22, the “Let's animate it” button 78 for animation quadrant 26 and the “Let's graph it” button 76 for graph quadrant 28. Once the summarize movie has been loaded by pressing the PS button 82, the program is structured so that the user must proceed through all of the summary steps in a linear way. When the summarize quadrant is fist loaded and clicked on, only one button is present “Identify useful info” (PS1). PS1 loads the movie TS1 into the text quadrant 22. TS1 in the text quadrant in turn contains a button that reloads PS1 and adds PS2 to the summarize quadrant. There are now two button in the Summarize quadrant, PS1 and PS2. WHen PS2 is clicked TS2 is loaded in the text quadrant. TS2 in turn contains a button that will load PS3 into the summariaze quadrant. There are now three buttons, PS1, PS2 and PS3 in the summarize quadrant. The user can now return to the first step if desired (PS1), or the second. The user can flexibly move between different summary steps only after having gone through the step at least once, until TS5 is reached, which will lead the user through the steps required to solve the problem (P5a to P5c in the procedure quadrant). TS5 branches to a set of movies Tsa, TSb, TSc and TSd. The last solution step movie (TSd) contains a button that terminates the flow of the first problem and loads the next problem into the text quadrant.

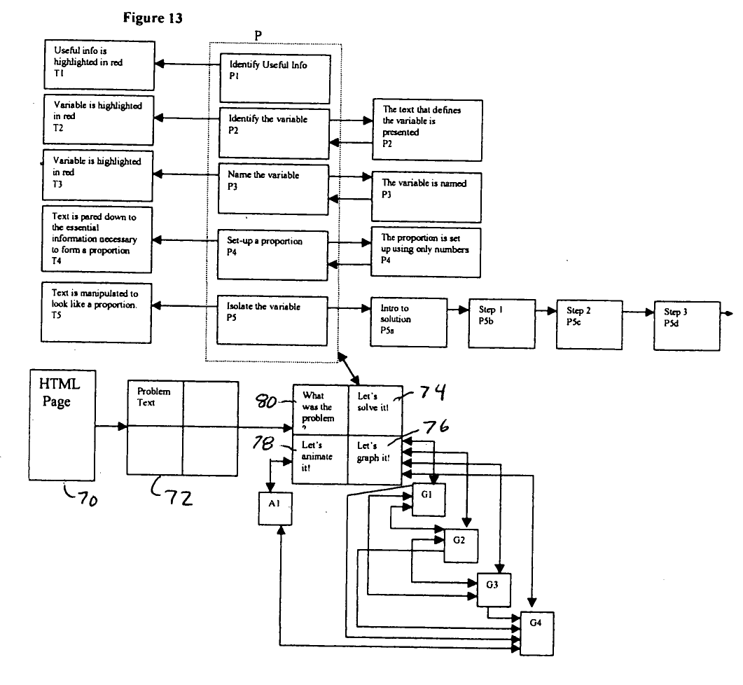

FIG. 13 illustrates the functional connection betweeen the text quadrant 22 and the procedure quadrant 24, with the procedural quadrant controlling the flow of the program. When movie P is loaded (by clicking on “Let's solve it” button 74), the user is presented with 5 buttons that can be clicked, P1-P5. When “Identify uesful information” (P1) is loaded, the text that contains any information that is important for the student to understand in order to solve the problem text in T1 is highlighted. It is important to note that nothing changes in the procedure quadrant 24. For steps P2-P5, buttons are pressed in P which load these movies, and target the procedure quadrant 24. For example when P2 is loaded (from movie called “P”) the P2 movie replaces P and also loads T2 into the text quadrant 22. While P2-P4 allow the users to return back to P where they can choose any button to click on, once P5 is loaded, it starts a solution sequence that cannnot be repeated. The fist step (P5a movie) contains a button that loads P5b, which in turn contains a button that loads P5c, which contains a button that loads P5d. Finally, P5d contains a button that loads the summarize movie (PS of FIG. 11) into the procedural quadrant (P).

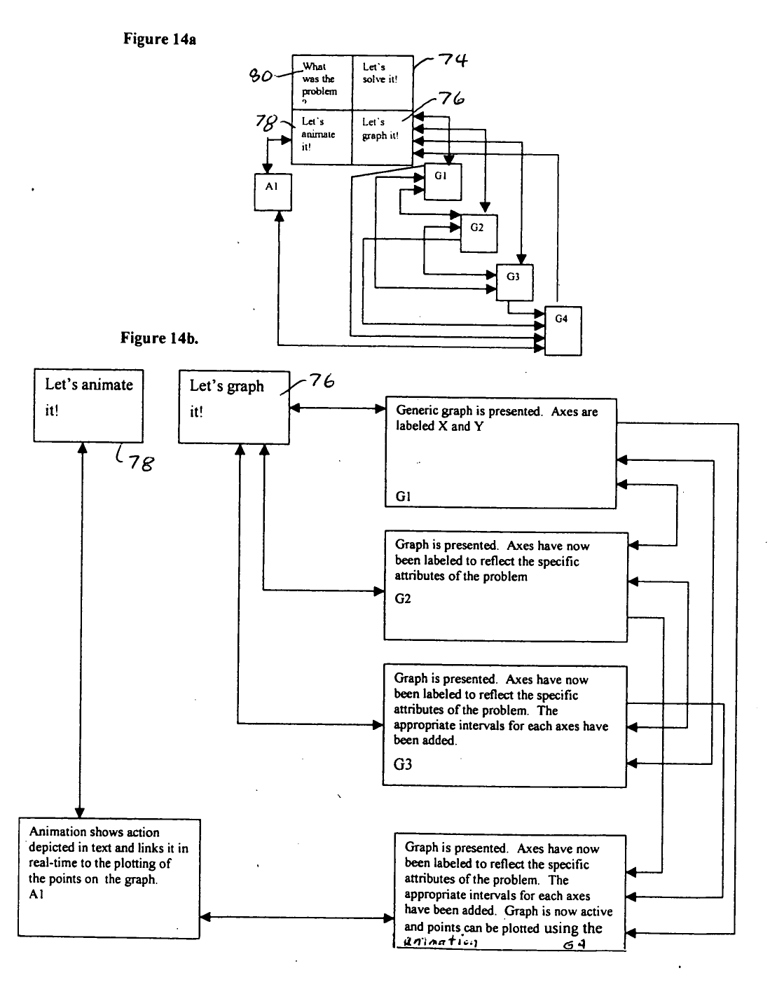

FIG. 14a provides a schematic of how the graph works in conjunction with the animation. When the user clicks on “Let's graph it” button 76, the user is presented with a generic graph (G1). G1 contains 5 buttons, 1 button loads a movie that has the axes labled according to the parameters of the problem (G2), 1 button loads a movie that adds the appropriate scale to each axes (G3). The third allows the user to return to the generic graph (G1), the fourth button (G4) simulataneuously opens the fully labeled graph as well as the animation which is used to control the graphing procedures. The student can manipulate the animation and see how the manipulations are reflected in the graph. Fnally there is a hide button (not shown in FIG. 14a) on the movie which will re-load the “Let's graph it” button 76. All of the graph movies (G1-G4) contain the same buttons, so the user can return to look at a generic graph, even after the user has labelled the axes (by loading G3), or the user can go directly from the generic axes (G1) to the “Let's graph it” movie (G4).

What is unique to each graph movie is how the hide button functions. If the user is working with the graph that is already labeled (G2) and the user decides to hide the graph, upon revealing it again, the user will return to the same graph (G2). Likewise, if the student is working with the graph that has the appropriate scale (G3) and decides to hide it, when the student returns, it will be to G3. This is true for all of the graph movies, except for G4. Once the graph (G4) has been hidden, upon revealing the quadrant, the user is returned to G1.

FIG. 14b shows a detailed functional description of FIG. 14a. In addition, the diagram shows that as the animation plays, the points are plotted in real time on the graph. The graph can also be hidden while the animation plays. The details of movie files G1, G2, G3, and G4 are also described in functional blocks, within the overall structure of the program.

FIG. 15 illustrates the functional relationship between the procedure, text and animation quadrants during the “Set up a proportion” function. When a “Set up a proportion” button is clicked, P4 is loaded into P. At the same time, T4 is loaded into the text quadrant 22, and the play-head of the animation is advanced to the end of the animation that shows the two figures in the form of a proportion (see also FIG. 10).

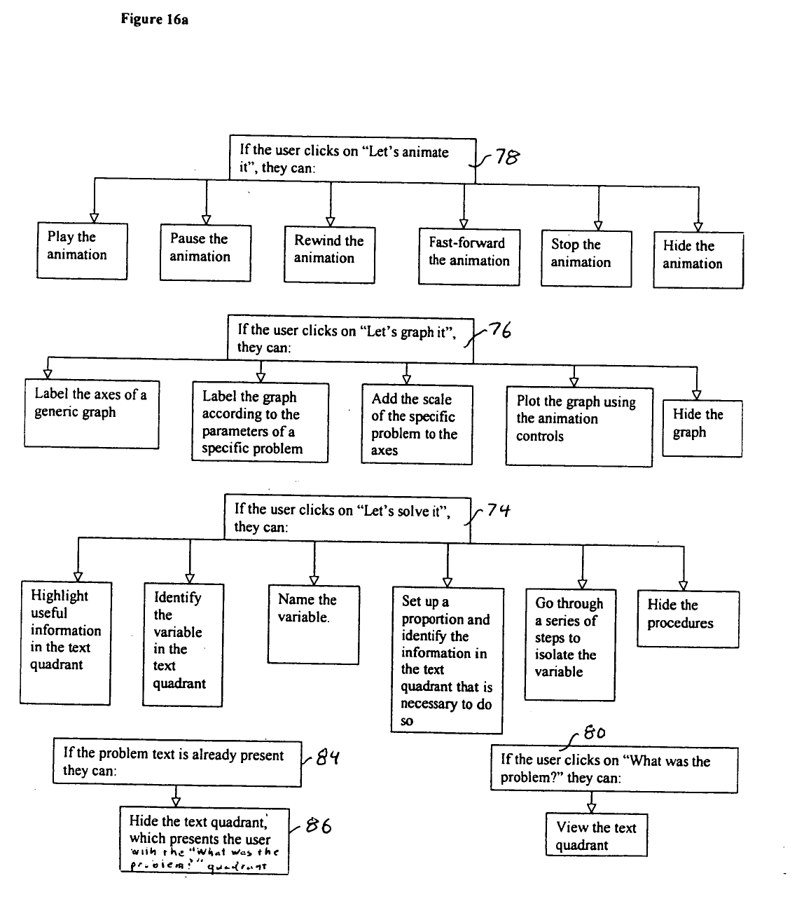

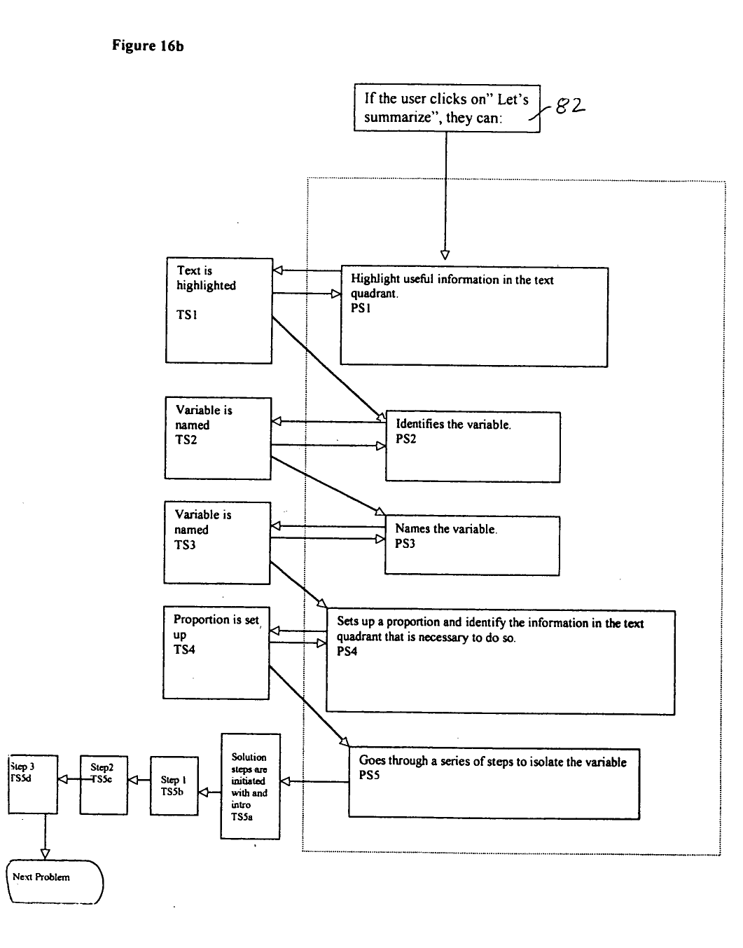

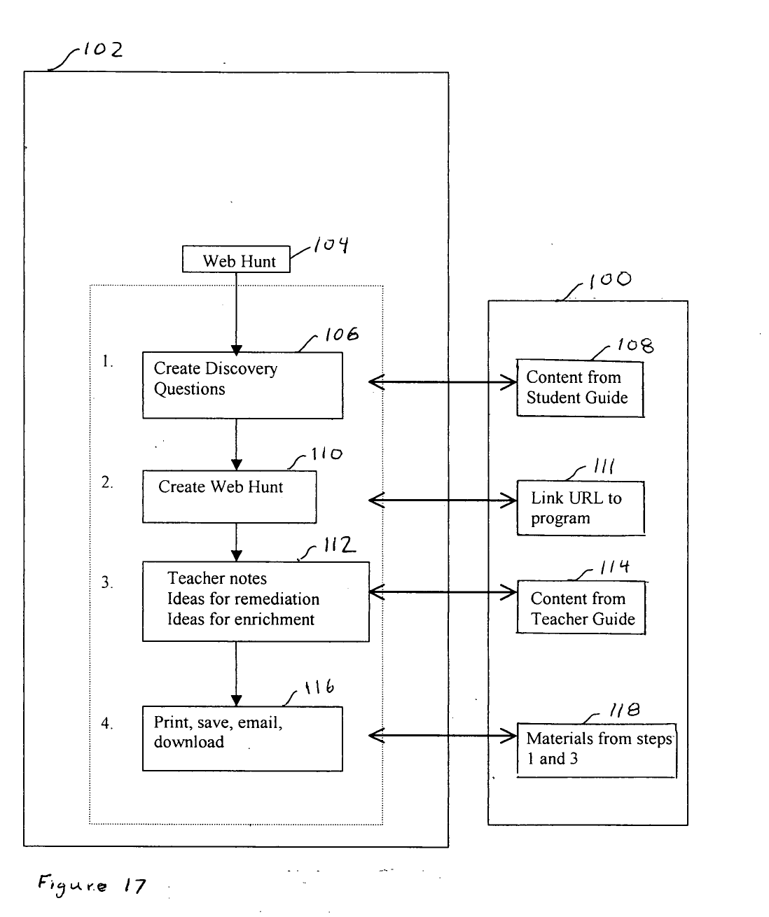

FIG. 16a illustrates a functional overview of the text, animation, graph and procedure quadrants and the choices that users have, if a user clicks on the respective buttons 78, 76, 74 and 80. It also shows the option 84, if the problem text is already present, of hiding the text quadrant so as to replace it with the “What was the problem” text at 86. The diagram does not include how the quadrants intereact with each other.

FIG. 16b illustrates a functional overview of the summarize quadrant and how it relates to the text quadrant. The graph and animation have been left out of the diagram because they function in the same manner as in FIG. 16a.

While the system of the present invention is platform independent, there are certain educational delivery platforms which can link the system to online written curriculum and activities and which subsequently extend the capabilities of the system. For example, Quickmind, a proprietary educational platform owned by Sunburst Technologies of Elgin, Ill. provides a means by which materials that have been developed online are linked to the program of the present invention. Materials which are developed for the system include a teacher guide, which outlines how the tool can be used in order to maximize its pedagogical impact when used in the classroom, as well as a student guide which offers the same support when the student uses the system in a remote situation without the teacher present. These materials can be e-mailed to teachers and students and downloaded onto local machines. Homework based on the classroom lecture using the system can be e-mailed to students, who download the assignments, complete them and bring them to class, where the teacher can then conduct a review of the homework using the same problems that were assigned to the students.

Referring to FIG. 17, the integration of the two systems occurs in the following manner.

1. A Link to the program 100 in accordance with the invnetion is stored in a category of Quickmind on the Quickmind net 102 called a Web Hunt 104. (Web Hunts involve visiting different urls and having students answer questions based upon the content of the URL).

2. The student is presented with a number of created questions 106 that need to be answered and which guide the students' exploration of the URL. This is where the student guide 108 may be uploaded. The students can download these questions and answer them as they explore the program.

3. The third step includes giving the activity a name to create a Web Hunt 110 and providing the link 111 to the URL to the program 100.

4. The fourth step allows the teacher to write notes 112 about the assignment including ideas for remediation as well as for enrichment. This is where the teacher curriculum is uploaded 114.

5. The fifth step generates at least two written documents at 116; one for the teacher, that includes notes, ideas for remediation and enrichment (and can include the entire guide). The second document contains the questions for the students.

6. These materials can then be saved to a community database, e-mailed to other teachers or students directly, downloaded or printed at 118.

The present invention can be realized in hardware, software, or a combination of hardware and software. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus, the invention includes an article of manufacture that comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. The concepts of this invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art. Thus, it should be understood that the embodiments has been provided as an example and not as a limitation. The scope of the invention is defined by the appended claims.

What is claimed is:

1. A system for instruction, comprising:
a display having a plurality of display portions, each portion being for representing a different mental representation of a problem; and
a flexible control for determining what representations are and are not revealed at a given time, so as to allow for customized lessons and reduction in visual overload.

2. The system of claim 1, further comprising architecture that supports varied content.

3. The system of claim 2, wherein said content comprises a series of frames, said frames being linked to one another by said architecture.

4. The system of claim 1, wherein said representations comprise:
a verbal statement of the problem;
an animation of the problem;
a procedure for solving the problem; and
a graphical representation of the problem.

5. The system of claim 1, wherein one of said representations comprises a procedural section that provides scaffolding for the solution of the problem when used remotely or when no teacher is present.

6. The system of claim 1, wherein one of said representations comprises a procedural section with a methodical step-by-step solution process.

7. The system of claim 1, wherein the representations are defined by an educational theory.

8. The system of claim 1, wherein the representations express knowledge, as at least one of factual knowledge, imagery knowledge, procedural knowledge and mechanism knowledge.

9. The system of claim 1, wherein the display comprises a SMART Board™ to record interactive lessons (using the program).

10. The system of claim 1, further comprising a network connection for uploading lessons, for access over the network.

11. The system of claim 10, configured so that the lessons are accessible by students at home.

12. The system of claim 10, wherein the lessons are archived in an electronic library, so that students and teachers have access to all lessons, including lessons from previous years as well as from different classes.

13. The system of claim 10, wherein schools have access to the lessons of other schools pursuant to membership in a consortium.

14. The system of claim 13, wherein said membership is provided with purchase of a SMART Board™ display.

15. The system of claim 1, further comprising an electronic archive; and an access structure for allowing tutors and resource/special education teachers to access the archive.

16. The system of claim 1, further comprising a database of movies searchable by a number of fields so that any of tutors, teachers, students, and parents can cross-reference different schools in the consortium to gather all lessons to facilitate exposure to different styles, and multiple perspectives.

17. The system of claim 1, further comprising an architecture for supporting varied content, wherein said content comprises a series of frames, wherein each of said frames displays a series of movies, a sequence of said movies being controlled by at least one of a student and a teacher.

18. The system of claim 17, wherein said series of movies contain buttons for switching between movies.

19. The system of claim 17, wherein said frames are displayed in said portions of said display.

20. The system of claim 19, wherein said portions are quadrants of said display.

21. The system of claim 17, further comprising selected constraints on said sequence in which said frames are accessed.

22. The system of claim 21, wherein accessing certain of said movies prevents again accessing others of said movies.

23. The system of claim 22, further comprising a procedure function and a summarize function for display in a frame, and program code for preventing the user from returning to the procedure function from the summarize function.

24. A method for teaching, comprising:
providing a display having a plurality of display portions, each portion being for representing a different mental representation of a problem; and
determining what representations are and are not revealed at a given time, so as to allow for customized lessons and reduction in visual overload.

25. The method of claim 24, wherein said content comprises a series of frames, said frames being linked to one another by a programmed instructional sequence.

26. The method of claim 24, wherein said representations comprise:
a verbal statement of the problem;
an animation of the problem;
a procedure for solving the problem; and
a graphical representation of the problem.

27. The method of claim 24, wherein one of said representations comprises a procedural section that provides scaffolding for the solution of the problem when used remotely or when no teacher is present.

28. The method of claim 24, wherein one of said representations comprises a procedural section with a methodical step-by-step solution process.

29. The method of claim 24, wherein the representations are defined by an educational theory.

30. The method of claim 24, wherein the representations express knowledge, as at least one of factual knowledge, imagery knowledge, procedural knowledge and mechanism knowledge.

31. The method of claim 24, further uploading lessons, via a network connection, for access over the network.

32. The method of claim 31, further comprising archiving the lessons in an electronic library, so that students and teachers have access to the lessons.

33. The method of claim 31, further comprising granting to schools access to the lessons of other schools pursuant to membership in a consortium.

34. The method of claim 33, further comprising providing access to a database of movies searchable by a number of fields so that any of tutors, teachers, students, and parents can cross-reference different schools in the consortium to gather all lessons to facilitate exposure to different styles, and multiple perspectives.

35. The method of claim 24, further comprising supplying varied content, wherein said content comprises a series of frames, wherein each of said frames displays a series of movies, a sequence of said movies being controlled by at least one of a student and a teacher.

36. The method of claim 25, wherein said series of movies contain buttons for switching between movies, and a user of the method operating said buttons.

37. The method of claim 35, comprising displaying said frames in said portions of said display.

38. The method of claim 37, wherein said portions are quadrants of said display.

39. The method of claim 35, further comprising imposing selected constraints on said sequence in which said frames are accessed.

40. The method of claim 39, wherein accessing certain of said movies prevents again accessing others of said movies.

41. The method of claim 22, comprising performing a procedure function and a summarize function, further comprising preventing the user from returning to the procedure function from the summarize function.

42. A method for operating a computer system for instruction, using the system of claims 1.

43. A method for distributing media on which a computer program for implementing the system of claims 1 is stored.

44. The method of claim 43, further comprising pooling information among different members of a consortium having members who have received and use the computer program.

45. A medium having computer readable code thereon for implementing the system of claim 1, when the medium is used with a computer.

46. A medium having computer readable code thereon for implementing the method of claim 24, when the medium is used with a computer.
